(19) United States
(12) Patent Application Publication
(10) Pub. No.: US 2025/0035447 A1
(43) Pub. Date: Jan. 30, 2025

(54) POSITION ESTIMATION DEVICE, POSITION ESTIMATION METHOD, AND POSITION ESTIMATION PROGRAM

(71) Applicants: DENSO CORPORATION, Kariya-city (JP); TOYOTA JIDOSHA KABUSHIKI KAISHA, Toyota-shi (JP)

(72) Inventors: SHUNYA KUMANO, Nisshin-city (JP); TAKESHI SHIKIMACHI, Tokyo-to Chuo-ku (JP)

(21) Appl. No.: 18/781,789

(22) Filed: Jul. 23, 2024

(30) Foreign Application Priority Data
Jul. 25, 2023 (JP) 2023-121121

(51) Int. Cl. G01C 21/30; G01C 21/00

(52) U.S. Cl. CPC G01C 21/30; G01C 21/3841

(57) ABSTRACT

By a position estimation device, a position estimation method, or a non-transitory computer-readable storage medium storing a position estimation program, a road reliability indicating whether a position estimation target vehicle exists for at least one road that has been adjusted on a PD map is calculated, and a road on which the position estimation target vehicle is traveling is estimated in consideration of a road that has not been adjusted on the PD map.

### CROSS REFERENCE TO RELATED APPLICATION

The present application claims the benefit of priority from Japanese Patent Application No. 2023-121121 filed on Jul. 25, 2023. The entire disclosure of the above application is incorporated herein by reference.

### TECHNICAL FIELD

The present disclosure of this specification relates to a technology for estimating a position of a subject vehicle using a PD map generated by collecting probe data from a plurality of vehicles.

### BACKGROUND

A technology of comparative example estimates which road a vehicle is traveling on among an elevated road and a road below the elevated road that are parallel to each other, using a digital road map database of a navigation device.

### SUMMARY

By a position estimation device, a position estimation method, or a non-transitory computer-readable storage medium storing a position estimation program, a road reliability indicating whether a position estimation target vehicle exists for at least one road that has been adjusted on a PD map is calculated, and a road on which the position estimation target vehicle is traveling is estimated in consideration of a road that has not been adjusted on the PD map.

### BRIEF DESCRIPTION OF THE DRAWINGS

FIG. 1 is a diagram showing a vehicle equipped with an own position estimation ECU.

FIG. 2 is a diagram showing a schematic configuration of a vehicle system and the own position estimation ECU.

FIG. 3 is a flowchart showing an example of processes executed by the own position estimation ECU.

FIG. 4 is a flowchart showing an example of processes executed by the own position estimation ECU.

FIG. 5 is a flowchart showing an example of processes executed by the own position estimation ECU.

FIG. 6 is a diagram illustrating an example of calculation of road reliability.

FIG. 7 is a diagram illustrating an example of the calculation of the road reliability.

FIG. 8 is a diagram illustrating an example of calculation of the road reliability.

FIG. 9 is a diagram showing an example of parallel roads.

FIG. 10 is a diagram illustrating an example of the calculation of the road reliability.

FIG. 11 is a diagram showing an example of the parallel roads.

FIG. 12 is a diagram illustrating an example of the calculation of the road reliability.

FIG. 13 is a diagram showing an example of the parallel roads.

FIG. 14 is a diagram illustrating an example of the calculation of the road reliability.

FIG. 15 is a flowchart showing an example of processes executed by the own position estimation ECU.

FIG. 16 is a diagram showing a schematic configuration of a vehicle system and the own position estimation ECU.

FIG. 17 is a flowchart showing an example of processes executed by the own position estimation ECU.

### DETAILED DESCRIPTION

Recently, there has been a study on generating a PD map by collecting probe data from a plurality of vehicles and using the map for vehicle travel. While the PD map can reflect the latest data collected from vehicles that have actually traveled on the roads, some of the roads that actually exist are not adjusted on the PD map in order to reduce a management cost of the PD map, or the like.

In this way, there is a possibility that adjusted roads and unadjusted roads coexist on the PD map. Under these circumstances, there is a demand for improving the accuracy of estimating the road on which the position estimation target vehicle is traveling.

One example of the present disclosure provides a position estimation device, a position estimation method, and a position estimation program for improving the accuracy of estimating a road on which a position estimation target vehicle is traveling.

According to one example embodiment of the present disclosure, a position estimation device estimates a position of a position estimation target vehicle by using a PD map generated by collecting probe data from a plurality of vehicles, and includes: a reliability calculation unit configured to calculate a road reliability indicating whether the position estimation target vehicle exists for at least one road that has been adjusted on the PD map; and a traveling road estimation unit configured to estimate a road on which the position estimation target vehicle is traveling, in consideration of a road that has not been adjusted on the PD map, based on a calculation result of the road reliability.

According to another example embodiment of the present disclosure, a position estimation method is executed by at least one processor for estimating a position of a position estimation target vehicle by using a PD map generated by collecting probe data from a plurality of vehicles, and includes: calculating a road reliability indicating whether the position estimation target vehicle exists for at least one road that has been adjusted on the PD map; and estimating a road on which the position estimation target vehicle is traveling, in consideration of a road that has not been adjusted on the PD map, based on a calculation result of the road reliability.

Further, according to another example embodiment of the present disclosure, a non-transitory computer-readable storage medium stores a position estimation position estimation program for estimating a position of a position estimation target vehicle by using a PD map generated by collecting probe data from a plurality of vehicles, and the position estimation program causes at least one processor to: calculate a road reliability indicating whether the position estimation target vehicle exists for at least one road that has been adjusted on the PD map; and estimate a road on which the position estimation target vehicle is traveling, in consideration of a road that has not been adjusted on the PD map, based on a calculation result of the road reliability.

According to these configurations, the road reliability is calculated for the road that has been adjusted on the PD map. Then, the estimation of the road on which the position estimation target vehicle is traveling is performed based on the calculation result, and is performed not only on roads that have been adjusted on the PD map, but also on the assumption that the position estimation target vehicle is traveling on roads that have not been adjusted on the PD map. Therefore, even when the subject vehicle is traveling on a road that is not adjusted on the PD map, it is possible to reduce the possibility of erroneously estimating that the vehicle is traveling on a road that is adjusted in the PD map. Therefore, it is possible to improve the accuracy of estimating the road on which the position estimation target vehicle is traveling.

Hereinafter, a plurality of embodiments will be described with reference to the drawings.

### First Embodiment

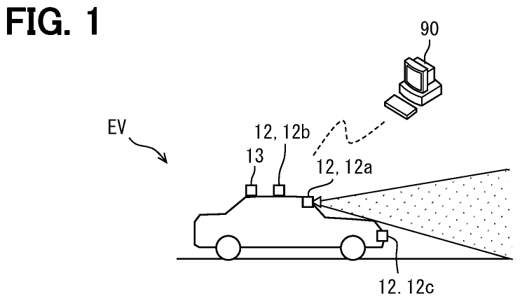

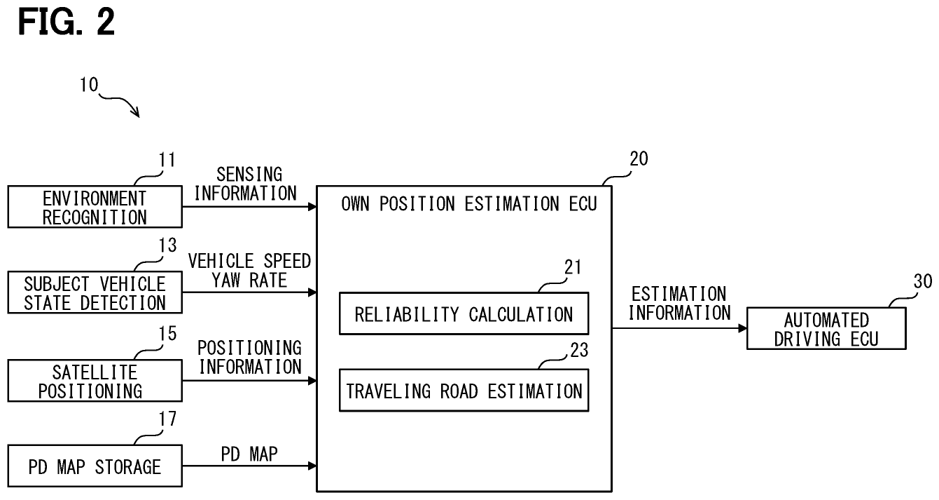

As shown in FIGS. 1 and 2, a vehicle system 10 according to the present embodiment is mounted on a vehicle. The vehicle system 10 is capable of performing autonomous control of driving (hereinafter, autonomous driving control) and can be used, for example, in vehicles with automation levels 2 to 5 (hereinafter, subject vehicle EV). In the present embodiment, an example in which the vehicle system 10 is installed in the subject vehicle EV with automation levels 3 to 5 will be described. In the present embodiment, the subject vehicle EV corresponds to a position estimation target vehicle.

Automation levels are classified into levels 0 to 5, as defined by SAE (Society of Automotive Engineers), for example. The level 0 is a level where the driver performs all driving tasks without any intervention of the system. The level 0 corresponds to so-called fully manual driving. The level 1 is a level where the system assists a steering operation or an acceleration and deceleration operation. The levels 1 corresponds to so-called driving assistance. The level 2 is a level where the system assists both the steering operation and the acceleration and deceleration operation. The level 2 corresponds to partial driving automation.

The level 3 is a level where the system can perform all the driving tasks under a specific condition and the driver performs the driving operation in an emergency. The level 3 corresponds to a conditional driving autonomation. The level 4 is a level where the system is capable of performing all driving tasks, except under a specific circumstance, such as an unsupported road, an extreme environment, and the like. The level 4 corresponds to a highly automated driving operation. The level 5 corresponds to a fully automated driving operation. The levels 3 to 5 may be classified as automated driving.

As shown in FIG. 2, the vehicle system 10 includes an environment recognition unit 11, a subject vehicle state detection unit 13, a satellite positioning unit 15, a PD map storage 17, an automated driving ECU 30, and an own position estimation ECU 20. The ECU is an abbreviation for Electronic Control Unit. These components may be communicatively connected to a communication bus of an in-vehicle network installed in the subject vehicle EV. These nodes connected to the communication bus can communicate with each other. Certain nodes among these components may be directly electrically connected to each other by a wire harness or the like, and may be able to communicate with each other without the communication bus.

The environment recognition unit 11 recognizes an external environment of the subject vehicle EV. The environment recognition unit 11 includes a plurality of autonomous sensors 12. The plurality of autonomous sensors 12 include at least one type of device, such as a camera 12a, a LIDAR (Light Detection and Ranging/Laser Imaging Detection and Ranging) 12b, a millimeter wave radar 13c, an ultrasonic sonar, and the like. These autonomous sensors 12 are combined and mounted on the subject vehicle EV to monitor each direction of the subject vehicle EV.

The plurality of autonomous sensors 12 preferably includes an image sensor capable of generating an image of the periphery of the subject vehicle EV. The image sensor may be the camera 12a that sequentially captures images of the periphery of the subject vehicle EV. The camera 12a is mounted, for example, at the upper end of the front windshield of the subject vehicle EV. The camera 12a outputs at least one of an image and a recognition result of the image as image data. The image may be a color image or a monochrome image. The image recognition result may be, for example, a result of identifying the type of object reflected in the image by semantic segmentation using a trained model of a neural network.

Further, the image sensor may also be the LiDAR 12b. The LiDAR 12b is mounted, for example, on the roof, the upper end of the front windshield, the front bumper, and the like of the subject vehicle. The LiDAR 12b scans a measurement area with laser light and detects the light reflected by objects in the measurement area as point cloud data. By converting the detected luminance values of each point according to the scanning position into two-dimensional data as pixel values, it becomes possible for the LiDAR 12b to output image data as well.

The environment recognition unit 11 may provide the detection results of the autonomous sensors 12 directly to the own position estimation ECU 20 as sensing information. The environment recognition unit 11 may provide the result of fusing the detection results of the autonomous sensors 12 to the own position estimation ECU 20 as the sensing information.

The subject vehicle state detection unit 13 includes a plurality of vehicle state sensors. The vehicle state sensor may include a vehicle speed sensor, a steering angle sensor, an acceleration sensor, and a yaw rate sensor. The vehicle speed sensor detects a travelling speed of the subject vehicle EV. The steering angle sensor is a sensor that detects the steering angle of the subject vehicle EV. The yaw rate sensor is a sensor that detects the angular velocity of the subject vehicle EV. The shift position sensor is a sensor that detects the shift position of the transmission of the subject vehicle EV. The subject vehicle state detection unit 13 detects information on the state of the subject vehicle, including, for example, the vehicle speed and yaw rate, and provides the information to the own position estimation ECU 20.

The satellite positioning unit 15 mainly includes, for example, a GNSS reception device that receives positioning signals transmitted from a plurality of artificial satellites (positioning satellites). The GNSS stands for Global Navigation Satellite System. The GNSS reception device is capable of receiving positioning information transmitted from respective positioning satellites of at least one satellite positioning system among a plurality of satellite positioning systems such as GPS, GLONASS, Galileo, IRNSS, QZSS, and Beidou.

The PD map storage 17 is a database that stores PD map data that can be used in the vehicle system 10. The PD map storage 17 includes, for example, at least one type of non-transitory tangible storage medium of a semiconductor memory, a magnetic medium, an optical medium, or the like. The PD map storage 17 is configured to be able to update the PD map by successively downloading the latest PD map from a map server 90 that is communicatively connected to the vehicle system via a communication device provided in the vehicle system 10.

The PD map is a map generated by the map server 90 by collecting probe data (hereinafter, PD) from the plurality of vehicles that are communicatively connected to the map server 90 and configured to be able to upload the PD to the map server 90. For example, the PD map includes road network data, lane network data, feature data, and POI (Point of Interest) data.

The road network data includes information on road position coordinates, road length, number of lanes, and connected roads. The lane network data is associated with the road network data, and includes the position coordinates of each lane, the length of the lane, and the like. The road network data and lane network data are prepared for, for example, target roads that are predetermined to be adjusted in consideration of the management costs of PD maps among actual roads. In other words, road network data and lane network data are not prepared for unadjusted roads other than the target road. In this way, roads that have been adjusted on the PD map and roads that have not been adjusted on the PD map coexist.

The unadjusted roads are determined according to specifications of the PD map. The unadjusted road may be, for example, a highway, a road other than a national highway or a trunk road (for example, a side road to a national highway), a road with two lanes or less, and the like.

The feature data includes a group of coordinate points of road edges, information on road markings, and information on three-dimensional objects. The information on the three-dimensional objects includes information on traffic signs, commercial signs, poles, guardrails, curbs, trees, utility poles, traffic lights, and the like installed along the roads.

The POI data is data on map elements other than those described above, which is associated with the road network data and the lane network data. The map elements include static map elements such as toll booths, tunnels, branching points, and merging points. The static map elements are required to be updated, for example, every week to every month. The map elements also include dynamic map elements such as congestion sections, construction sections, broken-down vehicles, fallen objects, accident locations, and lane restrictions. The dynamic map elements may require updates, for example, every few minutes to hours.

The PD map storage 17 provides the own position estimation ECU 20 with the latest PD map data downloaded from the map server 90.

The automated driving ECU 30 is an electronic control unit configured to be able to execute driving tasks of automation levels 3 to 5 on behalf of the driver. The automated driving ECU 30 is capable of autonomously driving the subject vehicle EV by autonomously controlling motion actuators such as the powertrain, steering, and brakes. During the automated driving, the automated driving ECU 30 refers to sensing information acquired from the environment recognition unit 11, and further to position information of the subject vehicle EV acquired from the own position estimation ECU 20.

The own position estimation ECU 20 is an electronic control unit that sequentially estimates the position of the subject vehicle EV based on information input from the environment recognition unit 11, the subject vehicle state detection unit 13, the satellite positioning unit 15, and the PD map storage 17. The estimation of the position of the subject vehicle EV here includes the estimation of the road on which the subject vehicle EV is traveling.

The estimation information estimated by the own position estimation ECU 20 is provided to, for example, an automated driving ECU and used for automated driving. For example, in a case where a plurality of roads with different speed limits are arranged parallel to one another, such as an expressway and a general road, when the road on which the subject vehicle EV is traveling is incorrectly estimated, the automated driving ECU 30 is likely to automatically drive the subject vehicle EV while misidentifying the speed limit. Therefore, the own position estimation ECU 20 is required to have an estimation accuracy that reduces the occurrence of erroneous operations during automated driving.

The own position estimation ECU 20 has at least one memory and at least one processor. The memory may be at least one type of non-transitory tangible storage medium, such as a semiconductor memory, a magnetic medium, an optical medium, and the like, which non-temporarily stores a computer program, data, and the like that can be read by the processor. Furthermore, for example, a rewritable volatile storage medium such as a random access memory (RAM) may be provided as the memory. The processor includes, for example, at least one type of a central processing unit (CPU), a graphics processing unit (GPU), and a reduced instruction set computer (RISC)-CPU as a core.

The own position estimation ECU 20 has a plurality of processing units that implement a position estimation function by the processor executing a computer program. Specifically, as shown in FIG. 2, the own position estimation ECU 20 includes a reliability calculation unit 21 and a traveling road estimation unit 23.

The reliability calculation unit 21 calculates the road reliability for each of one or more candidate roads that have been prepared on the PD map and on which the subject vehicle EV may be traveling. The road reliability here is a value indicating whether the subject vehicle EV exists on the road, and is a value that quantifies the existence possibility of the subject vehicle EV. The road reliability is a value calculated comprehensively from a plurality of features. The road reliability may be expressed as a probability that the subject vehicle EV is traveling on that road. The plurality of features here may include at least one of a change in the number of lanes, a position of the subject vehicle EV, and a trajectory of the subject vehicle EV. The plurality of features may further include other aspects, such as the degree of match of the target. The target object may be a sign such as a billboard, a road marking, or a structure such as a building or a bridge pier.

The reliability calculation unit 21 sequentially calculates the reliability based on each feature. Thereafter, the reliability calculation unit 21 substitutes the individual reliability based on each feature into a predetermined mathematical expression to calculate an overall road reliability. The mathematical expression here may be an appropriate expression, such as an expression based on a parallel model or an expression based on a majority model.

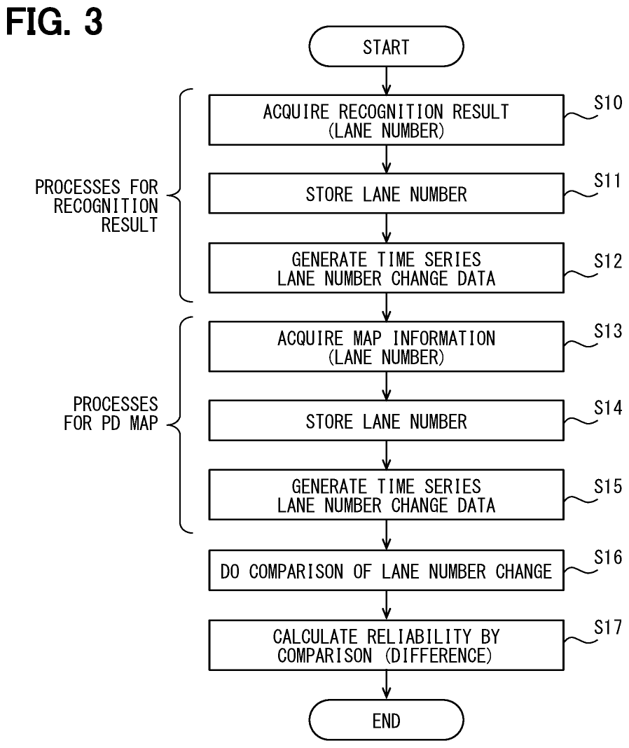

Here, an example of a method for calculating the reliability based on a change in the number of lanes by the process executed by the reliability calculation unit 21 will be described with reference to a flowchart of FIG. 3.

The processes in S10 to S13 are for processing the recognition results. In S10, the reliability calculation unit 21 acquires sensing information for a predetermined period up to the present from the environment recognition unit 11, and acquires a recognition result of the number of lanes from this sensing information. The recognition result of the number of lanes is, for example, the result obtained by the autonomous sensor 12 such as a camera 12a recognizing the number of lanes on the road on which the subject vehicle EV is traveling. After the process in S10, the process proceeds to S11.

In S11, the reliability calculation unit 21 temporarily stores the number of lanes acquired in S10 in a memory. After the process in S11, the process proceed to S12.

In S12, the reliability calculation unit 21 generates time-series lane number change data from the number of lanes stored in the memory. The time-series lane number change data is data that indicates a change over time in the number of lanes on the road on which the subject vehicle EV is traveling. After the process in S12, the process proceed to S13.

In S13, the reliability calculation unit 21 acquires the PD map, and acquires information on the number of lanes of the road for which the reliability is to be calculated from the PD map. After the process in S13, the process proceed to S14.

In S14, the reliability calculation unit 21 temporarily stores the number of lanes acquired in S13 in a memory. After the process in S14, the process proceed to S15.

In S15, the reliability calculation unit 21 generates time-series lane number change data from the number of lanes stored in the memory. The time-series lane number change data calculated in S15 is data obtained by converting information on the number of lanes obtained from the PD map into a format that can be compared with the time-series lane number change data calculated in S12. After the process in S15, the process proceed to S16.

In S16, the reliability calculation unit 21 compares the time-series data on change in the number of lanes obtained from the recognition result with the time-series data on change in the number of lanes obtained from the PD map. The comparison here may be calculation of the difference between the data. After the process in S16, the process proceed to S17.

In S17, the reliability calculation unit 21 calculates a reliability based on the change in the number of lanes from the comparison result (for example, a difference). The greater the difference, the lower the reliability value, and the smaller the difference, the higher the reliability value. After S17, the process ends.

The order of the processes in S10 to S12 and the processes in S13 to S15 may be interchanged. The processes of S10 to S12 and the processes of S13 to S15 may be executed in parallel at the same time.

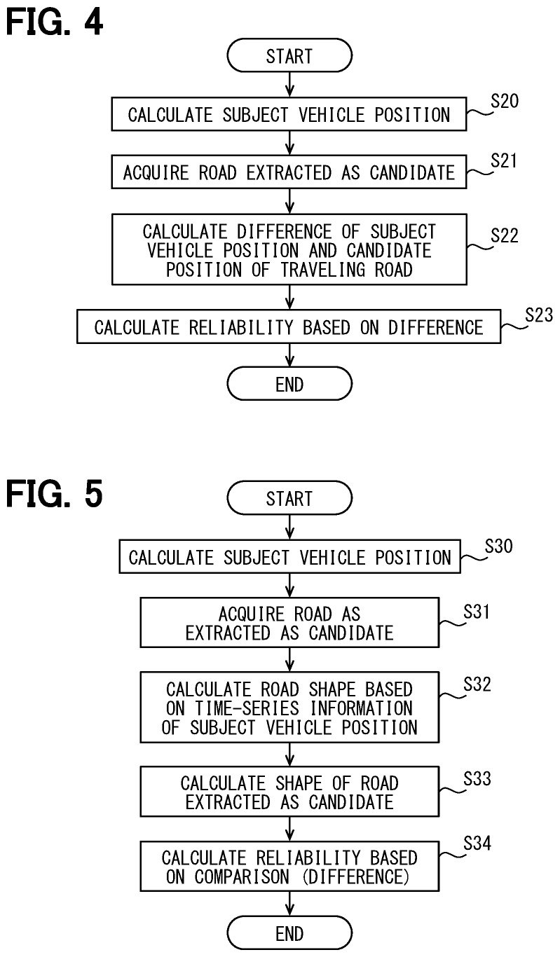

Next, an example of a method for calculating the reliability based on the position of the subject vehicle EV by the process executed by the reliability calculation unit 21 will be described with reference to a flowchart of FIG. 4.

In S20, the reliability calculation unit 21 calculates the position of the subject vehicle EV based on the positioning information acquired from the satellite positioning unit 15 and the vehicle speed, yaw rate, and the like acquired from the subject vehicle state detection unit 13. The position of the subject vehicle EV here may be the position of the subject vehicle EV expressed by, for example, latitude and longitude. After the process in S20, the process proceeds to S21.

In S21, the reliability calculation unit 21 acquires road information of the PD map that is extracted as a candidate road on which the subject vehicle EV is traveling based on the position of the subject vehicle EV. After the process in S21, the process proceeds to S22.

In S22, the reliability calculation unit 21 compares the position of the subject vehicle EV with the position of the candidate road, and calculates the difference between the positions. After the process in S22, the process proceeds to S23.

In S23, the reliability calculation unit 21 calculates the reliability based on the position of the subject vehicle EV from the difference calculated in S22. The greater the difference, the lower the reliability value, and the smaller the difference, the higher the reliability value. The series of processes ends after S23.

Next, an example of a method for calculating the reliability based on the trajectory of the subject vehicle EV by the process executed by the reliability calculation unit 21 will be described with reference to a flowchart of FIG. 5.

In S30, the reliability calculation unit 21 calculates the position of the subject vehicle EV, similarly to S20. After the process in S30, the process proceeds to S31. In S31, the reliability calculation unit 21 acquires road information of the PD map, similarly to S21. After the process in S31, the process proceeds to S32.

In S32, the reliability calculation unit 21 calculates the trajectory of the subject vehicle EV from the time-series information of the position of the subject vehicle EV acquired in S30. The trajectory of the subject vehicle EV is estimated to be the shape of the road on which the subject vehicle EV is traveling. After the process in S32, the process proceeds to S33.

In S33, the reliability calculation unit 21 calculates the shape of the road from the road information acquired in S31. After the process in S33, the process proceeds to S34.

In S34, the reliability calculation unit 21 compares the shape of the road estimated from the trajectory of the subject vehicle EV with the shape of the road calculated from the PD map. Then, the reliability calculation unit 21 calculates a reliability based on the change in the number of lanes from the comparison result (for example, a difference). The greater the difference, the lower the reliability value, and the smaller the difference, the higher the reliability value. The series of processes ends after S34.

For example, in the case of the relationship between S20 and S30, or the relationship between S21 and S31, overlapping processes are not executed for each calculation of the reliability, but are executed together in advance. In S20 and S30, the results of processes executed in advance may be referenced.

Here, the roads that have been adjusted in the PD map and are the subject of calculation of the road reliability may be the roads extracted in S31 and S32. Alternatively, the reliability calculation unit 21 may preliminarily select a candidate for a road for which road reliability is to be calculated based on the PD map, and execute the processes of the flowcharts shown in FIGS. 3 to 5 by limiting the processing to the selected candidate. The road reliability calculation target may be only roads on which the subject vehicle EV may be traveling. Roads on which there is absolutely no possibility that the subject vehicle EV is physically traveling may be excluded in advance from the calculation targets.

The traveling road estimation unit 23 compares the road reliability of each road that has been adjusted on the PD map and is the subject of the calculation of the road reliability. Based on the result of this comparison, the traveling road estimation unit 23 estimates the road on which the subject vehicle EV is traveling. This estimation is performed by including unadjusted roads on the PD map.

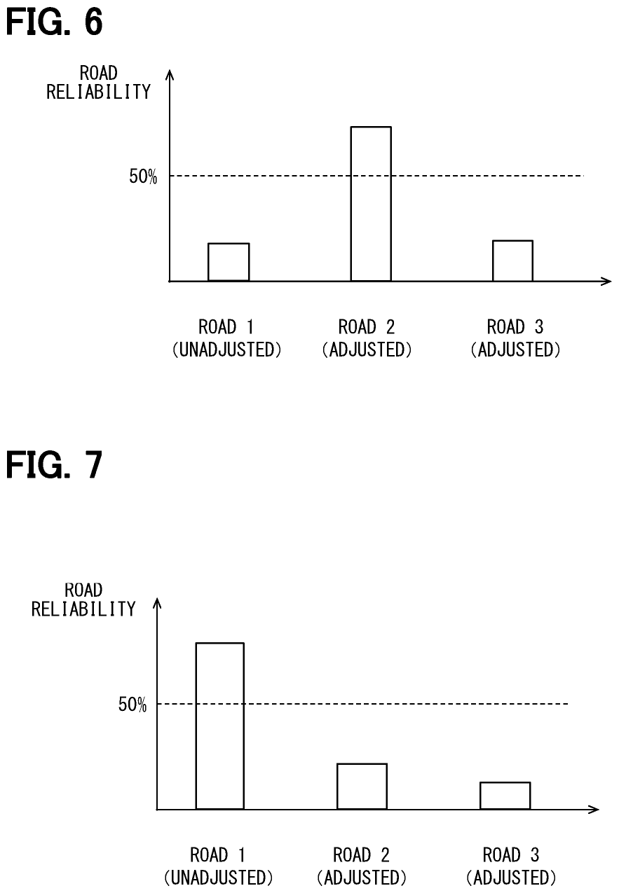

For example, as shown in FIGS. 6 to 8, roads 2 and 3 are targets for calculating the road reliability as roads that have been adjusted on the PD map. A road 1 is the unadjusted road on the PD map. Whether the existence of the actual road 1 is recognized by the own position estimation ECU 20 is not a major issue in the road estimation process. The traveling road estimation unit 23 may estimate the road reliability of the road 1, which is a road not yet unadjusted on the PD map, to be the value obtained by subtracting the road reliability of road 2 and the road reliability of road 3 from 100%.

In the example of FIG. 6, the road reliability of road 2 is the highest, and is greater than a preset threshold value (for example, 50%). In this case, the traveling road estimation unit 23 estimates that the road on which the subject vehicle EV is traveling is the road 2 and outputs the estimation result.

In the example of FIG. 7, all roads that have been prepared on the PD map and are the subject of calculation of road reliability (that is, roads 2 and 3) have the road reliability of less than 50%. In this case, the traveling road estimation unit 23 estimates that the road on which the subject vehicle EV is traveling is the unadjusted road on the PD map. When the existence of road 1 is recognized as the unadjusted road on the PD map, the traveling road estimation unit 23 may output the estimation result that the road on which the subject vehicle EV is traveling is the road 1. In a case where the existence of the unadjusted road is not recognized on the PD map, the traveling road estimation unit 23 may output, as the estimation result, a result that the road on which the subject vehicle EV is traveling is not adjusted on the PD map. A result of “unknown”, which means that estimation is impossible, may be output as the estimation result.

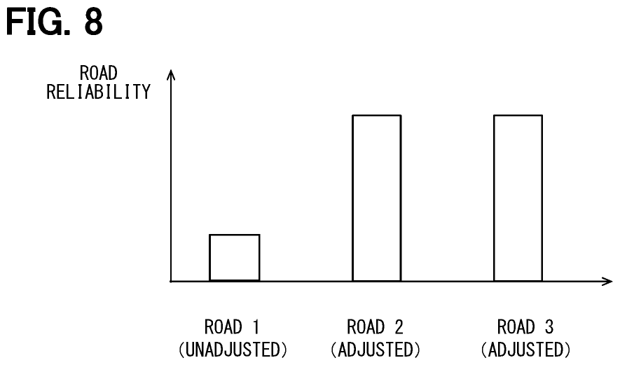

In an example of FIG. 8, the road reliability of roads 2 and 3 are the same. In this case, the traveling road estimation unit 23 outputs a result indicating that the road on which the subject vehicle EV is traveling is “unknown.”

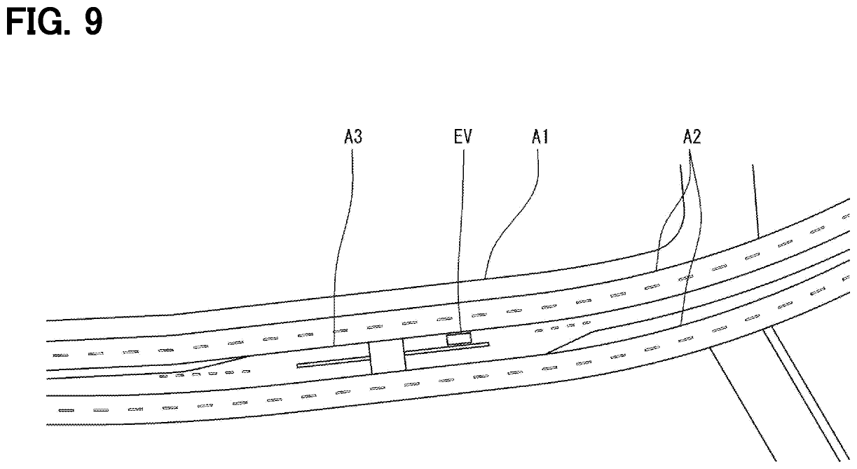

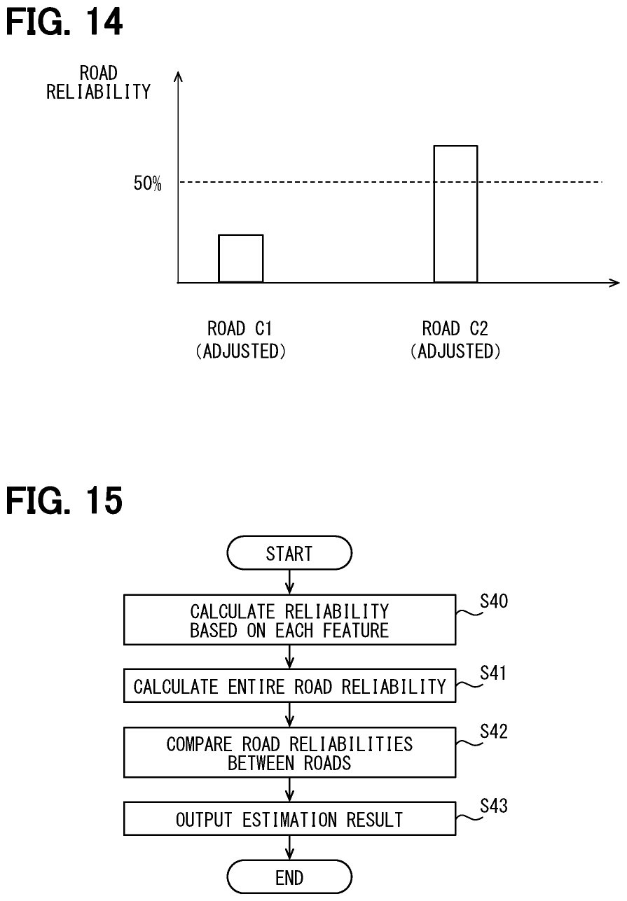

In the following, some more detailed examples will be described with reference to FIGS. 9 to 14. In the example of FIG. 9, three roads A1 to A3 are arranged parallel to each other. The road A1 is a side road to the roads 2 and 3, and is the unadjusted road on the PD map. The road A1 has one lane in each direction, and the number of lanes does not change. The road A2 is an expressway and is a road that has been unadjusted on the PD map. The road A2 is an elevated road with two lanes on each side, and is arranged to sandwich the road A3 on both sides. The road A3 is a road for entering the road A2, which is an expressway, from a general road, and is a road that has already been adjusted on the PD map. The number of lanes of the road A3 increases from one to two before a toll plaza, and then decreases from two to one after the toll plaza. The subject vehicle EV is traveling on the road A3.

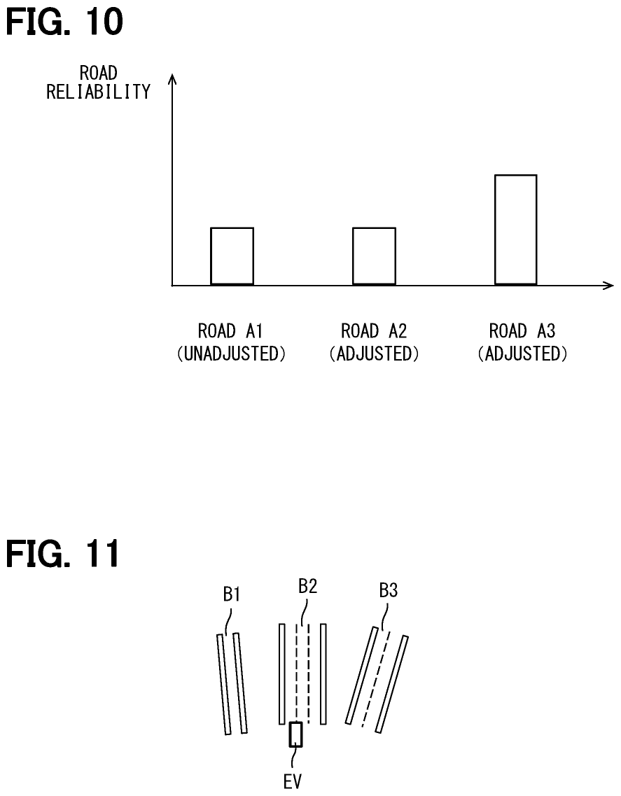

FIG. 10 shows the road reliability of each of the roads A1 to A3. Thereby, the road 3 has the highest road reliability. The road A3 is characterized by a change in the number of lanes, and therefore the reliability based on the change in the number of lanes is calculated to be high. Thereby, the road reliability of the road A3 is calculated to be the highest in terms of overall road reliability. The traveling road estimation unit 23 estimates that the road on which the subject vehicle EV is traveling is the road A3 and outputs the estimation result.

In the example of FIG. 11, three roads B1 to B3 are arranged parallel to each other. The road B1 is a road that has been unadjusted on the PD map. The road B1 has one lane and is marked on both sides of the road with solid white lines as road markings. The road B2 is a road that has been unadjusted on the PD map. The road B2 has three lanes and is marked with solid white lines on both sides of the road as road markings, and with two dashed white lines (lane dividing lines) sandwiched between the solid white lines on both sides as road markings. The road B3 is a road that has been unadjusted on the PD map. The road B3 has two lanes and is marked with solid white lines on both sides of the road as road markings, and with one dashed white line (lane dividing line) sandwiched between the solid white lines on both sides as road markings.

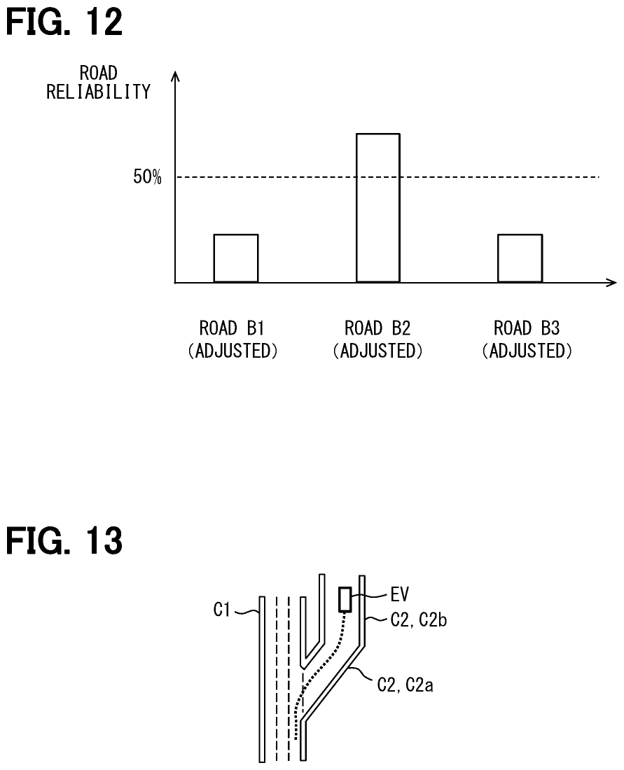

FIG. 12 shows the road reliability of each of the roads B1 to B3. Thereby, the road 2 has the highest road reliability. The road B2 is closer to the position of the subject vehicle EV calculated from the positioning information from the satellite positioning unit 15 than the roads B1 and B3. Therefore, the reliability based on the position of the subject vehicle EV on road B2 is calculated to be high. In addition, the matching rate between the road markings recognized by the autonomous sensor 12 such as the camera 12a and the road markings stored in the PD map is higher on the road B2 than on the roads B1 and B3. Therefore, the reliability based on the landmarks on road B2 is also calculated to be high. Thereby, the road B2 is also calculated to have the highest overall reliability. Since the road reliability of B2 exceeds 50%, it is determined that the possibility that the subject vehicle EV is traveling on a road that is not on the PD map is low. The traveling road estimation unit 23 estimates that the road on which the subject vehicle EV is traveling is the road B2 and outputs the estimation result.

In the example of FIG. 13, there are a road C1 and a road C2 branching off from the road C1. The road C1 is a general road and has been adjusted on the PD map. The road C1 is a straight road. The road C2 is a road that connects the road C1, which is a general road, with an expressway, and is a road that has already been adjusted on the PD map. The road C2 has an inclined portion C2a extending from the road C1 at an inclined angle with respect to the road C1, and a parallel portion C2b extending from the inclined portion C2a substantially parallel to the road C1.

FIG. 13 shows the road reliability of each of the roads C1 and C2. Thereby, the road C2 has the highest reliability. The matching rate between the curved trajectory of the subject vehicle EV and the shape of the road is higher on the road C2 than on the road C1. Therefore, the reliability based on the trajectory of the subject vehicle EV with respect to road C2 is calculated to be high.

Here, an example of a method for estimating the position of the subject vehicle EV by processes executed by the own position estimation ECU 20 will be described with reference to a flowchart of FIG. 15. In S40, the reliability calculation unit 21 calculates the reliability based on each feature. In S41 after the process of S40, the reliability calculation unit 21 calculates an overall road reliability from the reliability based on each feature. In S42 after the process of S41, the traveling road estimation unit 23 compares the road reliability between the roads. In S43 after the process of S42, the traveling road estimation unit 23 outputs an estimation result of the road on which the subject vehicle EV is traveling, based on the comparison. The series of processes ends after S43.

According to the first embodiment described above, the road reliability is calculated for roads that have been adjusted on the PD map. Then, the estimation of the road on which the subject vehicle EV as the position estimation target vehicle is traveling is performed based on the calculation result, and is performed not only on roads that have been adjusted on the PD map, but also on the assumption that the position estimation target vehicle is traveling on roads that have not been adjusted on the PD map. Therefore, even when the subject vehicle EV is traveling on a road that is not adjusted on the PD map, it is possible to reduce the possibility of erroneously estimating that the vehicle is traveling on a road that is adjusted on the PD map. Therefore, it is possible to improve the accuracy of estimating the road on which the subject vehicle EV is traveling.

Further, according to the first embodiment, the road reliability is calculated by comparing the information obtained from at least one of the sensing information from the autonomous sensor 12 mounted on the subject vehicle EV, the state of the subject vehicle EV, or the positioning information received from the satellite positioning system with the information on the PD map. Since the road on which the subject vehicle EV is traveling is estimated using such road reliability, the estimation accuracy is further improved.

Furthermore, according to the first embodiment, the reliability based on a plurality of mutually different features is calculated, and the road reliability is calculated as the overall reliability based on the reliability based on each feature. The accuracy of the estimation can be further improved by comprehensively assessing the plurality of features.

Furthermore, according to the first embodiment, the recognition result of the number of lanes on which the subject vehicle EV is traveling, based on the sensing information, is compared with information on the number of lanes of roads that have already been adjusted on the PD map. When the changes in the number of lanes in this comparison match, the reliability based on the changes in the number of lanes is calculated to be higher than when there is a difference in the changes in the number of lanes. The overall road reliability is calculated including the reliability based on such a change in the number of lanes, and this is used to estimate the road on which the subject vehicle EV is traveling. Therefore, the estimation accuracy is further improved.

Further, according to the first embodiment, the position of the subject vehicle EV calculated based on at least one of the sensing information, the state of the subject vehicle EV, and the positioning information is compared with the road position on the PD map. The smaller the difference between the position of the subject vehicle EV and the road position, the higher the reliability calculated based on the position of the subject vehicle EV. The overall road reliability is calculated including the reliability based on such a position of the subject vehicle EV, and this is used to estimate the road on which the subject vehicle EV is traveling. Therefore, the estimation accuracy is further improved.

Further, according to the first embodiment, the trajectory of the subject vehicle EV is obtained from the position of the subject vehicle EV calculated based on at least one of the sensing information, the state of the subject vehicle EV, and the positioning information. The trajectory is compared with the road position on the PD map. The smaller the difference between the trajectory of the subject vehicle EV and the road shape, the higher the reliability based on the trajectory of the subject vehicle EV is calculated. Since an overall road reliability is calculated including the reliability based on the trajectory of the subject vehicle EV, and the road on which the subject vehicle EV is traveling is estimated using this, the estimation accuracy is further improved.

Further, according to the first embodiment, when the road reliability of a specific road that has been adjusted in the PD map is higher than the road reliability of other roads and is higher than a preset threshold value, it is estimated that the subject vehicle EV is traveling on the specific road. In this way, it is possible to improve the validity of the estimation for roads that have already been adjusted on the PD map.

Furthermore, according to the first embodiment, when the road reliability of all roads that are the subject of road reliability calculation and that have been developed on the PD map is lower than a preset threshold value, it is estimated that the subject vehicle EV is traveling on a road that has not been developed on the PD map. In this way, it is possible to improve the validity of the estimation for roads that have not already been adjusted on the PD map.

Furthermore, according to the first embodiment, when the road reliability of all roads that are the subject of road reliability calculation and that have been adjusted on the PD map is lower than a preset threshold value, an estimation result is output and represents that the road on which the subject vehicle EV is traveling cannot be estimated. In this way, it is possible to avoid outputting erroneous estimation and to increase the validity of the estimation.

### Second Embodiment

The second embodiment is a modification of the first embodiment. The second embodiment will be described with focus on its differences from the first embodiment.

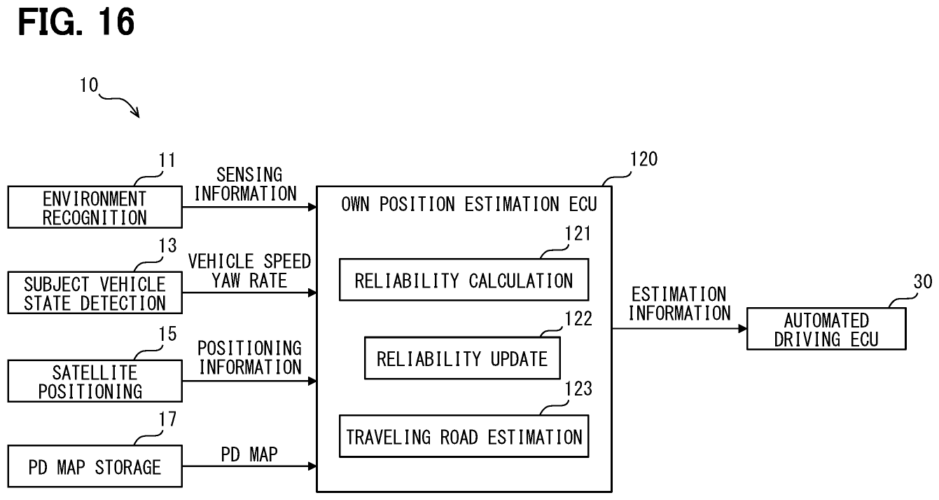

As shown in FIG. 16, an own position estimation ECU 120 of the second embodiment further includes a reliability update unit 122 as one of a plurality of processing units that implement a position estimation function by the processor executing a computer program (for example, a position estimation program).

The reliability update unit 122 holds the road reliability for each road calculated by the reliability calculation unit 121 until the next calculation of the road reliability. Then, the reliability update unit 122 calculates an updated road reliability value for each road based on the previous road reliability value and the current road reliability value. For example, when the previous value of the road reliability is CL, the current value of the road reliability is CT, and α is a weight value, the update value C is expressed by the following first equation.

C=(1−α)·CL+α·CT (First Equation)

Here, the weight value is set according to the movement status (for example, the movement distance) of the subject vehicle EV. Specifically, the memory stores a lookup table that defines the relationship between the vehicle speed and the weight value. Further, the memory also stores a lookup table that defines the relationship between the yaw rate and the weight value. The reliability update unit 122 acquires the vehicle speed and yaw rate from the subject vehicle state detection unit 13 and refers to the lookup table. Thereby, the reliability update unit 122 calculates the weight value according to the vehicle speed and a weight value according to the yaw rate.

In addition, the weight value is set according to the matching state in a comparison between information obtained from at least one of the sensing information from the environment recognition unit 11, the vehicle speed and yaw rate obtained from the subject vehicle state detection unit 13, or the positioning information obtained from the satellite positioning unit 15, and information on the PD map. This comparison process may utilize the calculation results used in the comparison processes (for example, S16, S22, and S33) executed by the reliability calculation unit 121 when calculating the road reliability. Alternatively, the comparison process may be executed by the reliability update unit 122 from the beginning. The matching state may be, for example, the number of matching targets when a plurality of targets recognized to be close to the subject vehicle EV are compared with targets on the PD map. The higher the matching state, the higher the weight value. When the matching state is given by the number of matches of targets, a larger weight value is set for a larger number of matches of targets.

The reliability update value may be calculated by calculating an overall weight value a to be substituted into the first equation from the weight value according to the vehicle speed, the weight value according to the yaw rate, and the weight value according to the coincidence state. According to this, by taking into account the movement state (temporal position change) of the subject vehicle EV, such as vehicle speed and yaw rate, the weight value is set to a larger value as continuation of the state of little change in the matching state becomes longer. The overall weight value a may be the sum of the weight values, the average, or a weighted average.

A travelling road estimation unit 123 in the second embodiment estimates the road on which the subject vehicle EV is travelling by using the updated value of the road reliability updated by the reliability update unit 122 instead of the road reliability (that is, the current value) calculated by the reliability calculation unit 121.

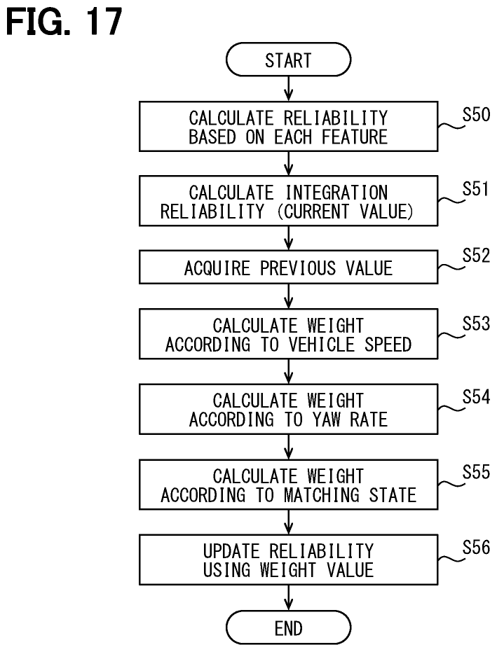

Here, an example of the reliability update method by the processes executed by the reliability calculation unit 121 and the reliability update unit 122 will be described with reference to the flowchart of FIG. 17.

In S50, the reliability calculation unit 121 calculates the reliability based on each feature. In S51 after the process of S50, the reliability calculation unit 121 calculates a current value of an overall road reliability from the reliability based on each feature. After the process in S51, the process proceeds to S52.

In S52, the reliability update unit 122 acquires the previous value of the overall road reliability. In S53 after the process of S52, the reliability update unit 122 calculates a weight value according to the vehicle speed. In S54 after the process of S53, the reliability update unit 122 calculates a weight value according to the yaw rate. In S55 after the process of S54, the reliability update unit 122 calculates a weight value according to the matching state. In S56 after the process of S55, the reliability update unit 122 calculates an update value of the road reliability using the weight values calculated in S52 to S55. The series of processes ends after S56.

According to the second embodiment described above, the road reliability is updated based on the previous value of the road reliability calculated previously and the current value of the road reliability calculated this time. Then, based on the updated road reliability, an estimation is made of the road on which the subject vehicle EV is traveling. By taking the previous value into consideration, it is possible to reduce erroneous estimation when the current value is affected by disturbance or the like.

Further, according to the second embodiment, at least one of the sensing information, the state of the subject vehicle EV, or the positioning information is compared with the information of the PD map. The weight value by which the current value is multiplied is set according to the duration of the matching state between the both information in this comparison. For example, in a case where there is a long period of time during which there is little change in the matching state, when the weight of the current value increases, it is possible to more quickly obtain the estimation result that identifies the road on which the subject vehicle EV is traveling from a state in which estimation is impossible. In other words, it is possible to shorten the time from when the subject vehicle EV passes a branch until the road on which the subject vehicle EV is traveling is identified.

### Other Embodiments

Although multiple embodiments have been described above, the present disclosure is not construed as being limited to those embodiments, and can be applied to various embodiments and combinations within a scope that does not depart from the spirit of the present disclosure.

In another embodiment, the functions of the own position estimation ECU 20 and the automated driving ECU 30 may be implemented by a single integration ECU. In this case, the integration ECU corresponds to the position estimation device.

In another embodiment, the position of the subject vehicle EV estimated by the own position estimation ECU 20 may be used for purposes other than autonomous driving control of the subject vehicle EV. For example, the position of the subject vehicle EV may be used to provide information or a warning to the driver via an in-vehicle display or the like.

In another embodiment, the position estimation device mounted on the subject vehicle EV may estimate the position of the other vehicle as the position estimation target vehicle. In this case, the vehicle speed and yaw rate of the other vehicle may be obtained using V2X communication.

In another embodiment, the position estimation device may not be mounted on a vehicle, and may remotely estimate the position of the position estimation target vehicle.

The controller and the method thereof described in the present disclosure may be implemented by a special purpose computer, which includes a processor programmed to execute one or more functions performed by computer programs. Alternatively, a device and its method according to the present disclosure may be implemented by a dedicated hardware logic circuit. Alternatively, the device and its method according to the present disclosure may be implemented by one or more dedicated computers including a combination of a processor executing a computer program and one or more hardware logic circuits. The computer program may also be stored on a computer-readable and non-transitory tangible storage medium as an instruction executed by a computer.

What is claimed is:

1. A position estimation device for estimating a position of a position estimation target vehicle by using a prove data (PD) map generated by collecting probe data from a plurality of vehicles, the position estimation device comprising:
a reliability calculation unit configured to calculate a road reliability indicating whether the position estimation target vehicle exists for at least one road that has been adjusted on the PD map; and
a traveling road estimation unit configured to estimate a road on which the position estimation target vehicle is traveling, in consideration of a road that has not been adjusted on the PD map, based on a calculation result of the road reliability.

2. The position estimation device according to claim 1, wherein
the reliability calculation unit is configured to calculate the road reliability by comparing information obtained from at least one type of sensing information from an autonomous sensor mounted on the position estimation target vehicle, a state of the position estimation target vehicle, or positioning information received from a satellite positioning system with information of the PD map.

3. The position estimation device according to claim 2, wherein
the reliability calculation unit is configured to
calculate a reliability based on a plurality of mutually different features, and
calculate a road reliability as an overall reliability based on the reliability based on each of the plurality of mutually different features.

4. The position estimation device according to claim 3, wherein
the reliability based on the plurality of mutually different features includes a reliability based on a lane number change,
the reliability calculation unit is configured to compare a recognition result of a lane number on which the position estimation target vehicle is traveling based on the sensing information with information of a lane number of a road that has been adjusted on the PD map, and
when the lane number change is matched, the reliability calculation unit calculates the reliability based on the lane number change to be higher than when a difference in the lane number change occurs.

5. The position estimation device according to claim 3, wherein
the reliability based on the plurality of mutually different features includes a reliability based on a position of the position estimation target vehicle, and
the reliability calculation unit is configured to compare the position of the position estimation target vehicle with a road position of the PD map,
the position of the position estimation target vehicle is calculated based on at least one type of the sensing information, a state of the position estimation target vehicle, or the positioning information, and
the calculated reliability based on the position of the position estimation target vehicle is higher as a difference between a position of the position estimation target vehicle and the road position is smaller.

6. The position estimation device according to claim 3, wherein
the reliability based on the plurality of mutually different features includes a reliability based on a trajectory of the position estimation target vehicle,
the reliability calculation unit is configured to compare the trajectory of the position estimation target vehicle with a road shape of the PD map,
the position of the position estimation target vehicle is calculated based on at least one type of the sensing information, a state of the position estimation target vehicle, or the positioning information, and
the calculated reliability based on the trajectory of the position estimation target vehicle is higher as a difference between a trajectory of the position estimation target vehicle and the road shape is smaller.

7. The position estimation device according to claim 1, wherein
the traveling road estimation unit estimates that the position estimation target vehicle is traveling on a specific road that has been adjusted on the PD map when the road reliability of the specific road is higher than the road reliability of a different road and also a preset threshold.

8. The position estimation device according to claim 1, wherein
the traveling road estimation unit estimates that the position estimation target vehicle is traveling on a road that has not been adjusted on the PD map when the road reliability of all roads that are set to a calculation target of the road reliability and have been adjusted is lower than a preset threshold.

9. The position estimation device according to claim 1, wherein
the traveling road estimation unit outputs an estimation result that estimation for a road on which the position estimation target vehicle is traveling is impossible when the road reliability of all roads that are set to a calculation target of the road reliability and have been adjusted on the PD map is lower than a preset threshold.

10. The position estimation device according to claim 1, wherein
the traveling road estimation unit outputs an estimation result that estimation for a road on which the position estimation target vehicle is traveling is impossible when the road reliability of each of two roads that are set to a calculation target of the road reliability and has been adjusted on the PD map has a same value.

11. The position estimation device according to claim 1, further comprising
a reliability update unit configured to update the road reliability based on a previous value of the road reliability and a current value of the road reliability,
wherein
the previous value is previously calculated by the reliability calculation unit,
the current value is currently calculated by the reliability calculation unit, and
the traveling road estimation unit is configured to estimate a road on which the position estimation target vehicle is traveling based on the road reliability updated by the reliability update unit.

12. The position estimation device according to claim 11, wherein
at least one of the reliability calculation unit or the reliability update unit is configured to perform comparison of information obtained from at least one type of sensing information from an autonomous sensor mounted on the position estimation target vehicle, a state of the position estimation target vehicle, or positioning information received from a satellite positioning system with information of the PD map, and
the reliability update unit is configured to set a weight value by which the current value is multiplied depending on a duration during which a matching state of the both information in the comparison continues.

13. A position estimation method executed by at least one processor for estimating a position of a position estimation target vehicle by using a PD map generated by collecting probe data from a plurality of vehicles, the position estimation method comprising:
calculating a road reliability indicating whether the position estimation target vehicle exists for at least one road that has been adjusted on the PD map; and
estimating a road on which the position estimation target vehicle is traveling, in consideration of a road that has not been adjusted on the PD map, based on a calculation result of the road reliability.

14. A non-transitory computer-readable storage medium storing a position estimation program for estimating a position of a position estimation target vehicle by using a PD map generated by collecting probe data from a plurality of vehicles, the position estimation program causing at least one processor to:
calculate a road reliability indicating whether the position estimation target vehicle exists for at least one road that has been adjusted on the PD map; and
estimate a road on which the position estimation target vehicle is traveling, in consideration of a road that has not been adjusted on the PD map, based on a calculation result of the road reliability.
